(19) United States
(12) Patent Application Publication
(10) Pub. No.: US 2002/0110693 A1
(43) Pub. Date: Aug. 15, 2002

(54) Glazing unit and method of making the same

(76) Inventor: David A. Richard, Shingles Springs, CA (US)

Correspondence Address: Price and Gess, Suite 250, 2100 S.E. Main Street, Irvine, CA, 92614-6238, US

(21) Appl. No.: 09/917,103

(22) Filed: Jul. 27, 2001

Related U.S. Application Data
(60) Provisional application No. 60/255,647, filed on Dec. 14, 2000.

(51) Int. Cl. B32B 27/36

(52) U.S. Cl. 428/412

(57) ABSTRACT

A glazing unit comprising a transparent laminate of three layers of dissimilar synthetic plastic materials and a method for manufacturing the same. Each layer comprises either a thermoplastic or thermoset synthetic plastic material. The three transparent layers include a clear layer of an acrylic, polymethyl methacrylate (PMMA) material, an interlayer of a polyurethane or a polyvinyl butyral (PVB) material, and a layer of a polycarbonate material. This construction provides a lightweight, durable, and transparent glazing unit capable of being utilized as a window in a vehicle or aircraft. The acrylic layer and polycarbonate layer are coated on all surfaces with an abrasion-resistant surface-hardening film. A multi-layer weather-resistant coating having a hydrophilic component and a hydrophobic component are applied to at least one of the outer surfaces of the glazing unit.

### RELATED APPLICATIONS

This application is a continuation of U.S. Provisional Patent Application Serial No. 60/255,647, filed Dec. 14, 2000.

### BACKGROUND OF THE INVENTION

1. Field of the Invention

The present invention relates generally to a glazing unit formed of a transparent laminate comprising three layers of dissimilar synthetic plastic materials. More particularly, the plastic glazing unit of the present invention is suitable for use as a window in automobiles or other vehicles.

2. Description of Related Art

At present, almost all automobile windows are formed of glass. History has shown numerous disadvantages exist with utilizing glass windows in automobiles. Glass tends to add a significant amount of weight to automobile. Further, glass poses a safety threat to passengers inside the automobile as glass has a tendency to shatter upon breakage. Thus, there are advantages which may be achieved by using highly transparent, optical quality plastic windows in place of glass. Plastic windows are lighter, tougher and less likely to fracture than glass lenses. There is a demand for fully practical plastic windows in the automotive industry due to its lightweight nature that contributes to the reduction of the gross weight of the vehicle. Further, plastic windows have been considered to be advantageous due to their non-breakableness that is favorable to the safety of the driver in case of an accident.

Transparent plastic materials which can be used as windows or other transparent enclosures are divided into two major classes, depending on their reaction to heat, thermoplastic materials and thermosetting materials. Thermoplastic materials will soften when heated and harden when cooled. These materials can be heated until soft and pliable, where they are formed into a desired shape. Upon cooling, thermoplastic materials will retain this shape. The same piece of thermoplastic can be reheated and reshaped any number of times without changing the chemical composition of the material. Thermosetting plastics differ in that they harden upon heating, and reheating has no softening effect. Thermosetting materials cannot be reshaped after once being fully cured by the application of heat. For this reason, thermosetting materials are rapidly being phased out in favor of acrylic, thermoplastic materials. Transparent plastics are manufactured in two forms: solid (monolithic) and laminated. Laminated plastic consists of two sheets of solid plastic bonded to a rubbery inner layer of material.

One problem associated with plastic windows mirrors is their significantly limited operational service life resulting from warpage or distortion of the windows due to the hygroscopic properties of thermoplastics or thermoset resins. Unlike their glass counterparts, windows formed with a thermoplastic or a thermoset resin as their substrate material gradually absorb moisture from the surrounding atmosphere. Over time, the absorption of moisture, coupled with variations in other climatic conditions, causes the thermoplastic or thermoset resin to expand and contract. The moisture permeability of various coatings applied to both sides of a plastic window often lead to different amounts of moisture being absorbed by the opposing surfaces of the plastic window, thus resulting in uneven expansion and contraction on both of its sides. This can cause a loss in optical clarity through the plastic window.

There is a need to provide a synthetic plastic window having a reduced susceptibility to hygroscopic effects. Furthermore, since synthetic plastic materials can be more susceptible to abrasions than glass, there is also a need for a synthetic plastic window which provides protection against impact damage while maintaining a high degree of optical clarity.

### SUMMARY OF THE INVENTION

The foregoing shortcomings and disadvantages of the prior art are alleviated by the present invention that provides a lightweight and durable synthetic plastic glazing unit. The glazing unit comprises a transparent laminate constructed of three layers of dissimilar synthetic plastic materials. Each layer comprises either a thermoplastic or thermoset synthetic plastic material. The three transparent layers include a layer of an acrylic material and a layer of a polycarbonate material having an interlayer of a polyurethane or a polyvinyl butyral (PVB) material positioned in between the two outer layers. The acrylic layer preferably comprises polymethyl methacrylate (PMMA). This construction provides a lightweight, durable, and transparent glazing unit capable of being utilized as a window in a vehicle or aircraft. The outer acrylic and polycarbonate layers are coated on all surfaces with an abrasion-resistant coating. Either or both of the outer layers of the glazing unit are further coated with a weather-resistant coating, where the weather-resistant coating comprises a surface-hardening hydrophilic coating covered by a hydrophobic coating. The hydrophilic coating comprises stacked layers of zirconia and silicone dioxide, while the hydrophobic coating comprises a perfluoroalkylsilane layer. The multi-layer weather-resistant coating increases the weatherability and durability of the glazing unit while maintaining the necessary optical clarity of the transparent glazing unit.

The present invention further provides a novel method of forming the glazing unit of the present invention. The acrylic layer is initially stretched to increase its physical properties. The interlayer is then positioned on an inner surface of either the acrylic layer or the polycarbonate layer. The inner surface of the remaining layer is then pressed against the exposed surface of the interlayer. The entire assembly is then placed into a hydraulic press and compressed together at approximately 200 psi. The entire assembly may be preheated by radiant heat and formed over a mating mold when the glazing unit is to be shaped having a surface other than a flat surface. The assembly is stretched as it is formed, a process which results in superior strength and flexibility. After compression, the preformed piece, still positioned onto the mold if shaped, is then placed in an autoclave and subjected to an annealing cycle under pressurized steam (autoclaving). After the autoclave procedure is complete and the temperature of the preformed piece has normalized, the glazing unit is then trimmed to the proper peripheral geometry. The abrasion-resistant coating and weather-resistant coating are then applied to the surfaces of the glazing unit.

### BRIEF DESCRIPTION OF THE DRAWINGS

The features of the present invention, which are believed to be novel, are set forth with particularity in the appended claims. The present invention, both as to its organization and manner of operation, together with further advantages, may best be understood by reference to the following description, taken in connection with the accompanying drawings in which the reference numerals designate like parts throughout the figures thereof and wherein:

FIG. 1 is a cross-sectional view of a preferred embodiment of the glazing unit of the present invention;

FIG. 2 is a cross-sectional view of another preferred embodiment of the glazing unit of the present invention; and

FIG. 3 is an enlarged cross-sectional view of a preferred embodiment of the coatings applied to the glazing unit of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a glazing unit.

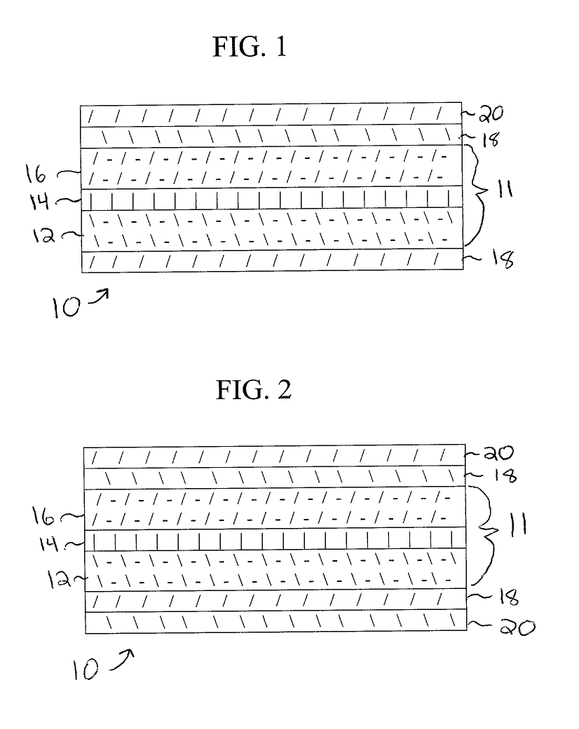

Referring now to FIG. 1, a cross-sectional view of a preferred embodiment of the glazing unit 10 of the present invention is illustrated. The glazing unit 10 comprises a transparent laminate 11 constructed of three dissimilar synthetic plastic layers. Each layers comprises either a thermoplastic or thermoset synthetic plastic material. The glazing unit includes optically transparent layers of an acrylic material 12 and a polycarbonate material 16 bonded together by an interlayer 14. The acrylic layer 12 preferably comprises a stretched polymethyl methacrylate EMMA), crystalline polymer. The interlayer 14 serves to bond the acrylic layer 12 to the polycarbonate layer 16 while providing relative movement between the acrylic layer 12 to the polycarbonate layer 16 to reduce strain which could occur from different thermal expansion characteristics. The interlayer 14 preferably comprises a ductile, optically clear, alliphatic, isocyanates-based, elastomeric, thermoplastic or thermoset polyurethane bonding membrane or a polyvinyl butyral (PVB) material. The polycarbonate layer 16 preferably comprises a Bisphenol-A-Polycarbonate material. In a preferred embodiment of the glazing unit 10 of the present invention, the acrylic PMMA layer 12 has a thickness of approximately 0.080″, the polyurethane interlayer layer 14 has a thickness of approximately 0.025″, and the polycarbonate layer 16 has a thickness of approximately 0.093″. However, it is understood that various layers of the glazing unit 10 may comprise other thicknesses and it is not the intention of the inventor of the present invention to limit the glazing unit 10 to these preferred thicknesses. The typical Coefficient of Linear Thermal Expansion (CLTE) for all of the layers in the glazing unit 10 is approximately 3.9 e-005 in/in per degree F. Each of the synthetic plastic layers in the glazing unit 10 may further be ultra-violet (UV) stabilized with a UV inhibitors in order to prevent color degradation over time.

In order to provide the glazing unit 10 with a sufficient degree of scratch resistivity, the acrylic layer 12 and the polycarbonate layer 16 may be coated on all surfaces with an abrasion-resistant “tie bond” coating 18 that has a base of an organosilicone (methylpolysiloxane) polymer with a thickness of approximately 2 to 10 microns. Furthermore, when the PMMA acrylic layer 12 is formed, PMMA is formed by polymerizing methyl methacrylate, where virtually all of the methyl methacrylate used to form the acrylic layer 12 reacts during the polymerization reaction to form PMMA. Some unreacted monomers do remain on the surfaces of the acrylic layer 12 as well as within the layer 12 itself. Those monomers within the acrylic layer 12 typically blush to the closest of either the surfaces following the molding process. The organosilicone tie-bond coating 18 also serves to eliminate any detrimental effects which these monomers may cause, thus rendering the acrylic layer 12 virtually chemically inert. This organo-silicone material is sprayed, dipped, or centrifugally coated onto the acrylic layer 12 and the polycarbonate layer 16 to form a tie-bond layer 18 on their surfaces. A typical organo-silicone is one prepared from triethoxymethyl silane CH₃Si(OC₂H₅)₃. The tie-bond layer 18 is, generally, permeable to humidity, for example, the rate of moisture absorption through the organo-silicon silane is about 3g/m² per 24 hours when tested in an atmosphere maintained at 50° C. with 98% room humidity.

A weather-resistant coating 20 is further applied to at least one outer surface of the glazing unit 10 to provide an additional degree of surface-hardening as well as providing protection from moisture and other external elements which could degrade the optical clarity or colorlessness of the glazing unit 10. The weather-resistant coating 20 is illustrated as being applied over the polycarbonate layer 16, but it is the intention of the inventor of the present invention that the weather-resistant coating 20 may alternatively be applied over the acrylic layer 12. In another preferred embodiment of the present invention, the weather-resistant coating 20 is applied to both outer surfaces of the glazing unit 10, as shown in FIG. 2.

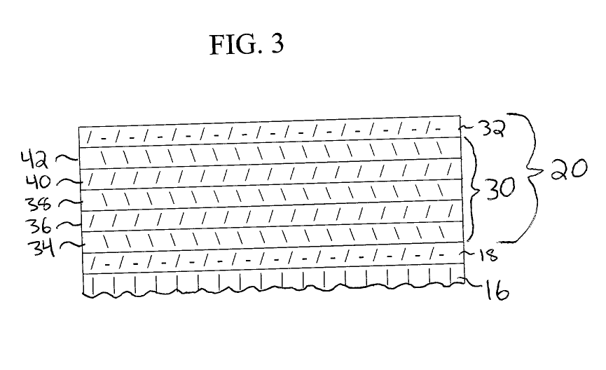

An enlarged, partial cross-sectional view of the glazing unit 10 is shown in FIG. 3 to illustrate the components of the weather-resistant coating 20. The weather-resistant coating 20 includes a multi-layer hydrophilic portion 30 covered by an outer hydrophobic portion 32. The hydrophilic portion 30 is formed in a stacked configuration comprising alternating layers of zirconia (ZrO₂) and silicon dioxide. A hydrophilic stack 30 of the following construction has been found by the inventors to provide optimal levels of abrasion resistance, transmission, and absence of color: a SiO₂ layer 34 of approximately 2616 angstrom, a ZrO₂ layer 36 of approximately 246 angstrom, a SiO₂ layer 38 of approximately 174 angstrom, a ZrO₂ layer of approximately 765 angstrom, and a SiO₂ layer of approximately 907 angstrom. The hydrophobic layer 32 is preferably a hydrophobic-acting perfluoroalkylsilane which forms a strongly adherent fluorised siloxane coating on the outer surface of the hydrophilic stack 30. The optimal coating thickness for the perfluoroalkylsilane layer 32 is approximately 5-20 nm.

By utilizing alternating layers of SiO₂ and ZrO₂ in the hydrophilic stack 30 in combination with the hydrophobic perfluoroalkylsilane layer 32, a weather-resistant coating 20 is provided which increases the weatherability and durability of the glazing unit 10 by affording a more abrasion-resistant and weather-resistant barrier. The layers of the hydrophilic stack 30 and the hydrophobic layer 32 are both dry coatings which are vacuum coated onto the surface of the tie-bond layer 18. By utilizing a dry coating technique, a more uniform, a flawless coating 20 can be achieved which is not readily achievable through wet coating techniques. Wet coatings are not ductile and tend to craze, resulting in fissures forming in the coatings where moisture can penetrate. By forming the weather-resistant coating 20 through a dry coating technique, the likelihood of these fissures forming is reduced significantly. Furthermore, the compositions of the hydrophilic stack 30 and the hydrophobic layer 32 are selected to have matching thermal coefficients of expansion, so that the various layers within the weather-resistant coating 20 expand and contract in a substantially uniform manner under all temperatures and conditions to which the glazing unit 10 is exposed. The thermal coefficient of expansion of the weather-resistant coating 20 is further matched against the other layers of the glazing unit 10, so that all of the various layers expand and contract in a substantially uniform manner. By matching the thermal coefficients of expansion of the various layers, the bonds formed between the layers are maintained in a secure manner to prevent the leakage of moisture there through. The above-described stack composition of the weather-resistant coating 20 has been found to provide a tougher, more weather resistant barrier to water infusion without adding color to the glazing unit 10 so as to maintain a high degree of optical clarity.

In order to illustrate the added protection which the weather-resistant coating 20 of the present invention provides to the glazing unit 10, the inventor of the present invention conducted Taber abrasion tests on polycarbonate and acrylic sheets coated by the weather-resistant coating 20 of the present invention as well as similar sheets coated with conventional silicone hardcoats comprising a polysiloxane polymer. The following table shows the results these abrasion tests on the surfaces of the polycarbonate and acrylic sheets.

Results of typical Taber abrasion tests after 300 cycles

| | | Primer | Abrasion |
|---|---|---|---|
| Coating type | Substrate | required | damage |
| Commercial silicone hardcoats | Polycarbonate | Yes | 4.1% |
| (polysiloxane polymers) | Acrylic | Yes | 7.5% |
| Weather-Resistant Coating 20 | Polycarbonate | No | 1.8% |
| | Acrylic | No | 2.8% |

As can be seen from the above results, the weather-resistant coating 20 of the present invention significantly reduced the amount of abrasion damage to both the polycarbonate and acrylic sheets which were tested. Thus, a glazing unit 10 formed in accordance with the present invention has an improved durability and resistance to degradation from external elements.

It is understood that the glazing unit 10 of the present invention can be formed to have various optical characteristics. For instance, both thermoplastics and thermosetting plastics may be highly transparent, opaque, or have any degree of clarity and light transmission in between. The total solar energy transmission may be as high as 90% with 92-93 in the visible region (400 to 750 nm). Transmission in the visible, ultraviolet (UV) and infrared (IR) is a variable (depending on the wavelength) and can be controlled to a large extent by the composition of the various layers of the glazing unit 10. Thus, the UV transmission may be cut off entirely by using UV absorbing additives to reduce deterioration of the plastic. Similarly, a substantial portion of the heat-inducing IR light can be either transmitted or absorbed, depending on the selected composition.

The present invention is further directed toward a novel and advantageous method of forming the glazing unit 10. The acrylic layer 12 is preferably formed of a stretched acrylic. Stretched acrylic is prepared from modified acrylic sheets, using a processing technique in which the sheet is heated to its forming temperature, approximately 200° F., and then mechanically stretched so as to increase its area approximately three or four times with a resultant decrease in its thickness. A masking paper is applied to the surfaces of the stretched acrylic to help to prevent accidental scratching during handling prior to coating. The stretched acrylic is a thermoplastic which conforms to Military Specification MIL-P-25690. The acrylic layer 12 comprises a transparent, solid, modified acrylic sheet material having superior crack propagation resistance (shatter resistance, craze resistance, fatigue resistance) as a result of proper hot stretching.

Polymethyl methacrylate (PMMA) is preferably utilized as the material for the acrylic layer 12. PMMA has been exploited as a safe replacement for glass in various window uses, since PMMA has the important advantages of being lighter and less brittle than glass, being more easily fabricated, and being much less likely to cause cuts and lacerations when broken. The development of the present invention to toughen and increase the glass transition temperature (T_{g}) of PMMA has further enhanced these advantages. There is a small temperature range for each of the polymer layers over which the polymer becomes much softer. The characteristic temperature for this softening is called the glass-transition temperature and is on the order of 100° C. below the melting temperature. Below the glass transition temperature, the polymer is hard: it is in its glassy range. Above the glass-transition temperature, the polymer is in its rubbery range where it is softer and rubber-like. The rubbery range extends to the melting temperature, above which the polymer is more like a fluid.

The transparent laminate 11 of the present invention is preferably formed according to the following method. Initially, the acrylic PMMA layer 12 is stretched to increase its physical properties as described above. The inner surfaces of the stretched PMMA layer 12 and the polycarbonate layer 16 are prepared in a dust free environment, where this preparation consists of pre-cleaning the surfaces with aliphatic naphtha in order to loosen any surface contamination. The cleaned surfaces should then be washed immediately with clear, de-ionized water and dried with static free, ozone enriched pressurized air. The pre-formed interlayer 14 is then positioned against one of the inner surfaces of either of the outer layers (PMMA layer 12 or polycarbonate layer 16). The other layer is then positioned over the exposed surface of the interlayer 14 and firmly pressed onto the exposed surface of the interlayer 14. The entire assembly is placed into a hydraulic press and compressed together at approximately 200 psi.

In the case where a surface other flat is desired, the assembly is preheated by radiant heat and formed over a mating mold. The preformed piece is stretched as it is formed, a process which results in superior strength and flexibility. This flexibility allows the glazing unit 10 to absorb vibrations and to resist cracking. After compression, the preformed piece, still positioned onto the mold if being shaped, is then placed in an autoclave and subjected to an annealing cycle under pressurized steam (autoclaving) for approximately 30 minutes at 250° F. The time and temperature are dependent on the mass of the part. After temperature normalization, the part is then trimmed to the proper peripheral geometry, such as by a CO₂ laser or an equivalent laser capable of cutting the media or other suitable trimming techniques available to those skilled in the art. The abrasion-resistant coating 18 is then applied to the formed transparent laminate 11, and the weather-resistant coating 20 is then vacuum coated over the abrasion-resistant coating to form the glazing unit 10.

The present invention describes a multi-layer plastic glazing unit 10 which may possess a variety of shapes and configurations. The glazing unit 10 is preferably designed as a window in an automobile or other vehicle, but it is understood that the glazing unit 10 may be utilized in other suitable applications as well. A glazing unit 10 formed in accordance with the present invention is advantageous due to its lightweight components, durability, and unbreakableness. Furthermore, as a result of the weather-resistant coating 20 applied to the glazing unit 10, the glazing unit 10 of the present invention does not exhibit noticeable warping or other mechanical distortion. In varied climatic conditions, the glazing unit 10 of the present invention remains dynamically stable. The coatings applied to the glazing unit 10 further impart significant resistance to mechanical damage from, for example, airborne particles. As a result, the glazing unit 10 of the present invention exhibits sufficient stability so as to comply with automobile industry test standards to enable the glazing unit to be used as a vehicle window.

As can be seen from the foregoing, a glazing unit formed in accordance with the present invention provides a lightweight and durable glazing unit. Further, the glazing unit of the present invention possesses increased weatherability by providing a more weather resistant barrier to water infusion as well as resistance to abrasion.

In each of the above embodiments, the different structures of the glazing unit are described separately in each of the embodiments. However, it is the full intention of the inventors of the present invention that the separate aspects of each embodiment described herein may be combined with the other embodiments described herein. Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A glazing unit, comprising:
a multi-layer transparent plastic laminate including:
a layer of acrylic material;
a layer of polycarbonate material; and
a synthetic plastic interlayer positioned between the acrylic layer and the polycarbonate layer;
an abrasion-resistant coating formed on an outer surface of at least one of said acrylic layer and said polycarbonate layer; and
a multi-layer weather-resistant coating formed over said abrasion-resistant coating.

2. The glazing unit of claim 1, wherein said abrasion-resistant coating is formed on the outer surfaces of both said acrylic layer and said polycarbonate layer.

3. The glazing unit of claim 2, wherein said multi-layer weather-resistant coating is formed over said abrasion-resistant coating on both said acrylic layer and said polycarbonate layer.

4. The glazing unit of claim 1, wherein said weather-resistant coating comprises a multi-layer hydrophilic coating and a hydrophobic coating.

5. The glazing unit of claim 4, wherein said multi-layer hydrophilic coating comprises alternating layers of silicon dioxide and zirconia.

6. The glazing unit of claim 5, wherein said multi-layer hydrophilic coating sequentially comprises from its outer surface toward its inner surface: a silicon dioxide layer, a zirconia layer, a silicon dioxide layer, a zirconia layer, and a silicon dioxide layer.

7. The glazing unit of claim 6, wherein said multi-layer hydrophilic coating sequentially comprises from its outer surface toward its inner surface: a silicon dioxide layer of approximately 907 angstrom, a zirconia layer of approximately 765 angstrom, a silicon dioxide layer of approximately 174 angstrom, a zirconia layer of approximately 246 angstrom, and a silicon dioxide layer of approximately 2616 angstrom.

8. The glazing unit of claim 4, wherein said hydrophobic coating comprises perfluoroalkylsilane.

9. The glazing unit of claim 8, wherein said perfluoroalkylsilane hydrophobic coating has a thickness of approximately 5-20 nm.

10. The glazing unit of claim 4, wherein said hydrophobic coating and said multi-layer hydrophilic coating are both dry coatings formed by a vacuum coating technique.

11. The glazing unit of claim 4, wherein said hydrophobic coating and said multi-layer hydrophilic coating have substantially equal thermal coefficients of expansion.

12. The glazing unit of claim 1, wherein said acrylic layer comprises a polymethyl methacrylate (PMMA) crystalline polymer.

13. The glazing unit of claim 11, wherein said PMMA polymer layer has a thickness of approximately 0.080″.

14. The glazing unit of claim 1, wherein said interlayer comprises polyurethane.

15. The glazing unit of claim 14, wherein said polyurethane interlayer has a thickness of approximately 0.025″.

16. The glazing unit of claim 14, wherein said interlayer comprises an optically clear, alliphatic isocyanates-based, elastomeric thermoplastic or thermoset polyurethane.

17. The glazing unit of claim 1, wherein said interlayer comprises polyvinyl butyral (PVB).

18. The glazing unit of claim 1, wherein said polycarbonate layer has a thickness of approximately 0.093″.

19. The glazing unit of claim 1, wherein said abrasion-resistant coating serves as a tie-bond layer.

20. The glazing unit of 19, wherein said abrasion-resistant coating is an organo-silicon polymer material.

21. The glazing unit of 20, wherein organo-silicon polymer material is triethoxymethyl silane.

22. The glazing unit of 21, wherein said organo-silicon abrasion-resistant coating has a thickness of approximately 2-10 microns.

23. The glazing unit of claim 1, wherein said glazing unit is utilized as an automotive window.

24. The glazing unit of claim 1, wherein at least one of the layers of said plastic laminate includes a UV inhibitor to provide UV (ultra-violet) stabilization.

25. A method of forming a glazing unit comprising the steps of:
positioning an interlayer of synthetic plastic material between a layer of acrylic material and a layer of polycarbonate material;
pressing said acrylic layer, said interlayer, and said polycarbonate layer together into a multi-layer laminated structure; and
annealing the layered structure using pressurized steam to form the laminated glazing unit.

26. The method of claim 25, further comprising stretching the acrylic layer prior to positioning said interlayer there against.

27. The method of claim 26, wherein the acrylic layer comprises a layer of stretched polymethyl methacrylate (PMMA) crystalline polymer.

28. The method of claim 25, wherein the layers are pressed together in a hydraulic press at a force of approximately 200 psi.

29. The method of claim 25, further comprising the step of shaping the laminated structure in a mold prior to annealing the layered structure when the glazing unit is to be shaped to possess a surface other than a flat surface.

30. The method of claim 25, further comprising the step of cutting the annealed layered structure to form a desired geometry for the glazing unit.

31. The method of claim 25, further comprising the steps of:
applying an abrasion-resistant coating to at least one surface of the formed glazing unit, and
applying a weather-resistant coating over said abrasion resistant coating.

32. The method of claim 31, wherein said weather-resistant coating is a dry coating which is vacuum coated onto said abrasion-resistant coating.

33. The method of claim 31, wherein said abrasion-resistant coating is formed on the outer surfaces of both said acrylic layer and said polycarbonate layer.

34. The method of claim 33, wherein said weather-resistant coating is formed over said abrasion-resistant coating on both said acrylic layer and said polycarbonate layer.

35. The method of claim 31, wherein said weather-resistant coating comprises a multi-layer hydrophilic coating and a hydrophobic coating.

36. The method of claim 35, wherein said multi-layer hydrophilic coating is formed by sequentially forming alternating layers of silicon dioxide and zirconia.

37. The method of claim 36, wherein said multi-layer hydrophilic coating is formed to sequentially comprise from its outer surface toward its inner surface: a silicon dioxide layer, a zirconia layer, a silicon dioxide layer, a zirconia layer, and a silicon dioxide layer.

38. The method of claim 37, wherein said multi-layer hydrophilic coating is formed to sequentially comprise from its outer surface toward its inner surface: a silicon dioxide layer of approximately 907 angstrom, a zirconia layer of approximately 765 angstrom, a silicon dioxide layer of approximately 174 angstrom, a zirconia layer of approximately 246 angstrom, and a silicon dioxide layer of approximately 2616 angstrom.

39. The method of claim 35, wherein said hydrophobic coating comprises perfluoroalkylsilane.

40. The method of claim 39, wherein said perfluoroalkylsilane hydrophobic coating is formed to have a thickness of approximately 5-20 nm.

41. The method of claim 35, wherein said hydrophobic coating and said multi-layer hydrophilic coating have substantially equal thermal coefficients of expansion.

42. The method of claim 27, wherein said PMMA polymer layer in the annealed glazing unit has a thickness of approximately 0.080″.

43. The method of claim 25, wherein said interlayer comprises polyurethane.

44. The method of claim 43, wherein said polyurethane interlayer in the annealed glazing unit has a thickness of approximately 0.025″.

45. The method of claim 43, wherein said interlayer comprises an optically clear, alliphatic isocyanates-based, elastomeric thermoplastic or thermoset polyurethane.

46. The method of claim 25, wherein said interlayer comprises polyvinyl butyral (PVB).

47. The method of claim 25, wherein said polycarbonate layer in the annealed glazing unit has a thickness of approximately 0.093″.

48. The method of claim 31, wherein said abrasion-resistant coating serves as a tie-bond layer.

49. The method of claim 48, wherein said abrasion-resistant coating is an organo-silicon polymer material.

50. The method of claim 49, wherein organosilicon polymer material is triethoxymethyl silane.

51. The method of claim 49, wherein said organo-silicon abrasion-resistant coating is formed to have a thickness of approximately 2-10 microns.

52. The method of claim 25, further comprising the step of adding a UV inhibitor to at least one of the layers of said glazing unit to provide UV (ultra-violet) stabilization.

53. The method of claim 25, wherein said glazing unit is formed to be an automotive window.
